(19) United States
(12) Patent Application Publication
(10) Pub. No.: US 2013/0174368 A1
(43) Pub. Date: Jul. 11, 2013

(54) DISPLACEABLE AXIAL BODY FOR A WIPER PIVOT DEVICE OF A MOTOR VEHICLE

(71) Applicant: GM Global Technology Operations LLC, Detroit, MI (US)

(72) Inventors: Udo Mildner, Limburg (DE); Stefan Gloger, Muehltal (DE)

(73) Assignee: GM GLOBAL TECHNOLOGY OPERATIONS LLC, Detroit, MI (US)

(21) Appl. No.: 13/724,010

(22) Filed: Dec. 21, 2012

(30) Foreign Application Priority Data
Dec. 22, 2011 (DE) 102011121898.3

(51) Int. Cl. B60S 1/04

(52) U.S. Cl. CPC B60S 1/04
USPC 15/250.3; 15/250.31

(57) ABSTRACT

An axial body for a windshield wiper device of a motor vehicle is provided. The axial body can include a pivot bearing receptacle, in which a wiper axis can be pivoted. In addition, the axial body can include a slide bearing guide, along which the axial body as a whole can be shifted when the axial body is exposed to a defined force.

### CROSS-REFERENCE TO RELATED APPLICATION

This application claims priority to German Patent Application No. 10 2011 121 898.3, filed Dec. 22, 2011, which is incorporated herein by reference in its entirety.

### TECHNICAL FIELD

The technical field relates to an axial body for a wiper pivot device of a motor vehicle, with a pivot bearing receptacle, into which a wiper axis can be pivoted, to a windshield wiper device that exhibits the axial body, as well as to a motor vehicle equipped with the windshield wiper device.

### BACKGROUND

In order to satisfy the requirements for protecting pedestrians in an impact event with a motor vehicle, it is known to give windshield wiper devices a collapsible design. To this end, wiper pivot devices in which a wiper axis is pivoted can be configured in such a way that they allow the wiper axis to retreat during an impact event. The crash energy released in the process is absorbed or transformed through the deformation of deformable components. DE 103 52 239 A1 relates to a windshield wiper device with a windshield wiper system that exhibits a wiper linkage, at least one wiper axis connected with the wiper linkage, and at least one wiper pivot that accommodates the wiper axis, as well as a receiving unit for the windshield wiper system, wherein the windshield wiper system is shiftably arranged in the receiving unit. It is provided that the receiving unit be joined with a housing encompassing at least one functional unit, and that the receiving unit and housing be designed in such a way as to allow the windshield wiper system to be shifted. To this end, in particular a linkage is pressed out of a mounting area of a receiving unit, and in the process transferred into a deformation area, during which the housing is deformed. DE 10 2009 056 237 A1 relates to a retaining structure for a windshield wiper axis for a vehicle. The retaining structure encompasses a first, essentially flat section, which extends in an x-direction and a y-direction, and in the x-direction exhibits a first end and a second end spaced apart from the latter. The retaining structure further encompasses a second, essentially flat section, which extends in a z-direction and the y-direction, and in the z-direction exhibits a first end and a second end spaced apart from the latter. The z-direction is situated at a predetermined angle relative to the x-direction. A connecting section of the retaining structure joins the second end of the first section with the first end of the second section at the predetermined angle. The first section exhibits a first bending stiffness, the second section a second bending stiffness, and the connecting section a third bending stiffness, each around a bending axis in the y-direction. The first bending stiffness is less than the second bending stiffness, and the second bending stiffness is less than the third bending stiffness. The second end of the second section exhibits an attachment structure for accommodating the windshield wiper axis. Given an impact event with a pedestrian, a force that acts on the second section causes the second section to deform into a radiator tank, as a result of which the windshield wiper axis submerges into the radiator tank. Furthermore, a folding of the first section may weaken a windshield cross member, wherein the latter deforms and absorbs impact forces.

Therefore, it may be desirable to enable pedestrian impact protection in the region of a windshield wiper of a motor vehicle, and in the event of such a pedestrian impact, keep the resulting repair costs as low as possible. In addition, other objects, desirable features and characteristics will become apparent from the subsequent summary and detailed description, and the appended claims, taken in conjunction with the accompanying drawings and this background.

### SUMMARY

Various exemplary aspects of the present disclosure provide an axial body for a wiper pivot device of a motor vehicle with a pivot bearing receptacle in which a wiper axis can be pivoted by means of a slide bearing guide that can shift the entire axial body during exposure to a defined force. The axial body as a whole, and hence also the pivot bearing receptacle complete with wiper axis incorporated therein, can advantageously be shifted along a path of movement defined by the slide bearing guide during exposure to the defined force. The defined force originates in particular from a pedestrian impact in the area of the wiper axis and/or a windshield wiper of the motor vehicle. The slide bearing guide can advantageously convert the kinetic energy released by the pedestrian impact into thermal energy via the friction that arises in the slide bearing guide. This advantageously causes the accelerations acting on the pedestrian colliding with the motor vehicle to diminish. No lasting deformation advantageously takes place in the slide bearing guide, so that advantageously only the axial body has to be shifted back into its original position after the pedestrian impact, thereby advantageously yielding comparatively low repair costs.

In one exemplary embodiment, the slide bearing guide is advantageously provided by an easy to manufacture, oblong recess in the rear wall of the axial body. The rear wall can advantageously be mounted with the rest of the motor vehicle in such a way that the defined force acts in the direction of a flat expansion of the rear wall. In particular, the direction of the defined force points towards a longitudinal direction of the oblong recess, wherein the longitudinal direction of the oblong recess denotes a direction of the path of movement for the slide bearing guide.

In another exemplary embodiment of the axial body, the pivot bearing receptacle can advantageously be used to accommodate a pivot bearing, in particular a ball bearing, for mounting the wiper axis, or mechanically allocate it to the axial body.

In another exemplary embodiment of the axial body the angle of the wiper axis relative to the rear wall can advantageously be used to set an angle between the wiper axis and the defined force.

In another exemplary embodiment of the axial body, a slide bearing device guided via the slide bearing guide can advantageously glide through the hole in the bearing plate after the oblong recess if the defined force arises, so that the entire axial body can advantageously be detached from the rest of the motor vehicle during exposure to the defined force.

In another exemplary embodiment of the axial body, a bearing shoe of the slide bearing device can advantageously be accommodated in the expansion, in particular positively, wherein fixing forces for fixing the axial body in place can be transferred into the expansion by way of the bearing shoe. A frictional force can advantageously be set on the bearing shoe via the constriction, wherein the frictional force counteracts the defined force. The constriction is thus part of the slide bearing guide, and defines the path of movement.

In another exemplary embodiment of the axial body, the constriction empties into the hole, wherein a sliding path of the slide bearing guide ends at a corresponding junction point, and a corresponding slide bearing device, in particular the bearing shoe, can glide through the hole, during which the entire axial body detaches from the rest of the motor vehicle. The slide bearing device or slide bearing guide thus exhibits no end stop, meaning that its design is free of stops.

In another exemplary embodiment of the axial body, a dual pivot bearing receptacle advantageously results, a partial pivot bearing receptacle on each bearing plate, so that in particular two roller bearings, in particular ball bearings, are or can be arranged on the respective bearing plates for mounting the wiper axis.

The present disclosure also provides a windshield wiper device of a motor vehicle with an axial body described above. The advantages described above are obtained.

Another exemplary embodiment of the windshield wiper device includes the bearing shoe that is advantageously mechanically fixed in place on the rest of the motor vehicle via the fixing means. The bearing shoe is positively mounted in the slide bearing guide, so that the axial body is or can be fixed in place on the rest of the motor vehicle via the bearing shoe and fixing means. In particular, the bearing shoe is or can be pretensioned by means of the fixing means, wherein a gliding force or frictional force that counteracts the defined force can be prescribed in addition to the constriction, which induces an elastic deformation of the bearing shoe as it glides through and a gliding force. In a normal state of the motor vehicle, the slide bearing guide or a slide bearing device formed by the bearing shoe and slide bearing guide are advantageously used to fix in place the axial body on the rest of the motor vehicle. In case of a crash or pedestrian impact, the axial body can retreat unscathed along the prescribed path of movement.

In another exemplary embodiment of the axial body, the rubbery elastic double collar bushing advantageously forms a vibration-damping rubber bearing for the axial body on the rest of the motor vehicle. Therefore, three functions are implemented, specifically fixability with the rest of the motor vehicle, retreat during exposure to the defined force, and noise decoupling of the wiper axis relative to the rest of the motor vehicle. The double collar bushing can be understood as a hollow cylindrical, in particular circular cylindrical, for example, oval cylindrical basic shape with a continuous groove arranged on the outside. The continuous groove can advantageously be used to establish the positive link with the slide bearing guide.

In another exemplary embodiment of the axial body, the axial body can advantageously be easily screwed with the rest of the motor vehicle.

In another exemplary embodiment of the axial body, advantageously provided are the axial body and additional axial body, and hence the wiper axis and additional wiper axis, so that two windshield wipers can be powered in a butterfly wiper operating mode. The retainers can be used to allocate the axial bodies to the rest of the motor vehicle in a mechanically fixed manner, in particular to the body of the motor vehicle. The retainers can advantageously be freely designed, so that a spatial arrangement of the axial body, and hence the slide bearing guide, can be established by means of the retainers.

In another exemplary embodiment of the axial body, the cross strut is advantageously arranged between the retainers. The cross strut can advantageously be used to stiffen the retainers. The retainers are advantageously allocated to the body of the motor vehicle, so that the motor vehicle body is also stiffened via the retainers. As a consequence, the cross strut is used as a reinforcing pipe of the windshield wiper device on the one hand, in particular to fix in place the drive unit, in particular a drive, in particular an electric motor and windshield wiper linkage. On the other hand, the cross strut is used to stiffen the motor vehicle body. In particular, the cross strut is allocated to spring domes of the motor vehicle body via the two retainers. The cross strut can advantageously replace a so-called cross strut brace for stiffening a chassis of the motor vehicle. This makes it possible to advantageously do without otherwise required retainers, in particular retainers in an engine compartment of the motor vehicle. This advantageously makes the motor vehicle more repair friendly. In particular, serviceability in the process of changing out lamps is enhanced by the potential elimination of a lock cross member structure above a headlamp as the result of using the cross strut of the wiper system as the strut brace.

The various exemplary aspects of the present disclosure also provide a motor vehicle with a windshield wiper device described above. This yields the advantages described above.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is a schematic side view of a motor vehicle with an impact region for a pedestrian impact;

FIG. 2 is a three-dimensional inclined view from the top front of a front end of the motor vehicle depicted on FIG. 1;

FIG. 3 is a three-dimensional inclined view from the top front onto the installation position of an axial body of a windshield wiper device of the motor vehicle depicted on FIG. 1 mounted with a wiper axis;

FIG. 4 is the axial body depicted on FIG. 3 wherein two bearing shoes are additionally shown;

FIG. 5 is a three-dimensional inclined view from the top rear onto the installation position of the axial body depicted on FIG. 4 as mounted with a retainer on the body side;

FIG. 6A and 6B is a respective sectional view along the A-A line depicted on FIG. 5, in a mounted state as depicted on FIG. 5, and by comparison thereto in a displaced state; and

FIG. 7 is a detailed, inclined view from the bottom front of a windshield wiper device of the motor vehicle depicted on FIG. 1.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

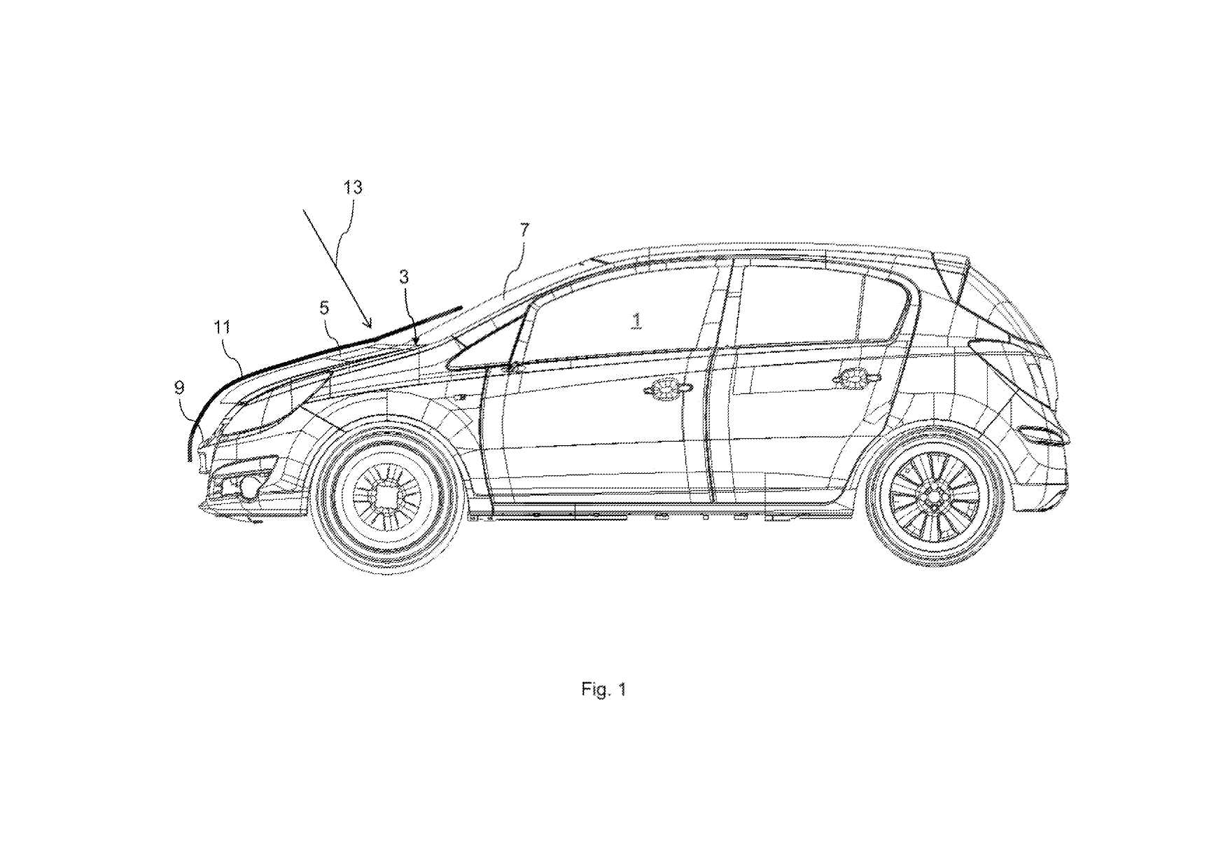

FIG. 1 shows a schematic side view of a motor vehicle 1. The motor vehicle 1 exhibits a windshield wiper device 3 that is not visible in any greater detail on FIG. 1 and is covered by a hood 5. The windshield wiper device 3 is used for wiping a windshield 7 of the motor vehicle 1. The motor vehicle 1 exhibits an impact region 11, in which the components shift in such a way as to specifically protect a pedestrian during a collision. The impact region 11 extends from a bumper 9 over the hood 5, the underlying windshield wiper device 3 and the windshield 7. An impact direction 13, in one example, of the head of a pedestrian potentially colliding with the motor vehicle 1, is marked in the region of the windshield wiper device 3. The impact direction 13 is a direction in which the impact probability is highest, generally under standard conditions.

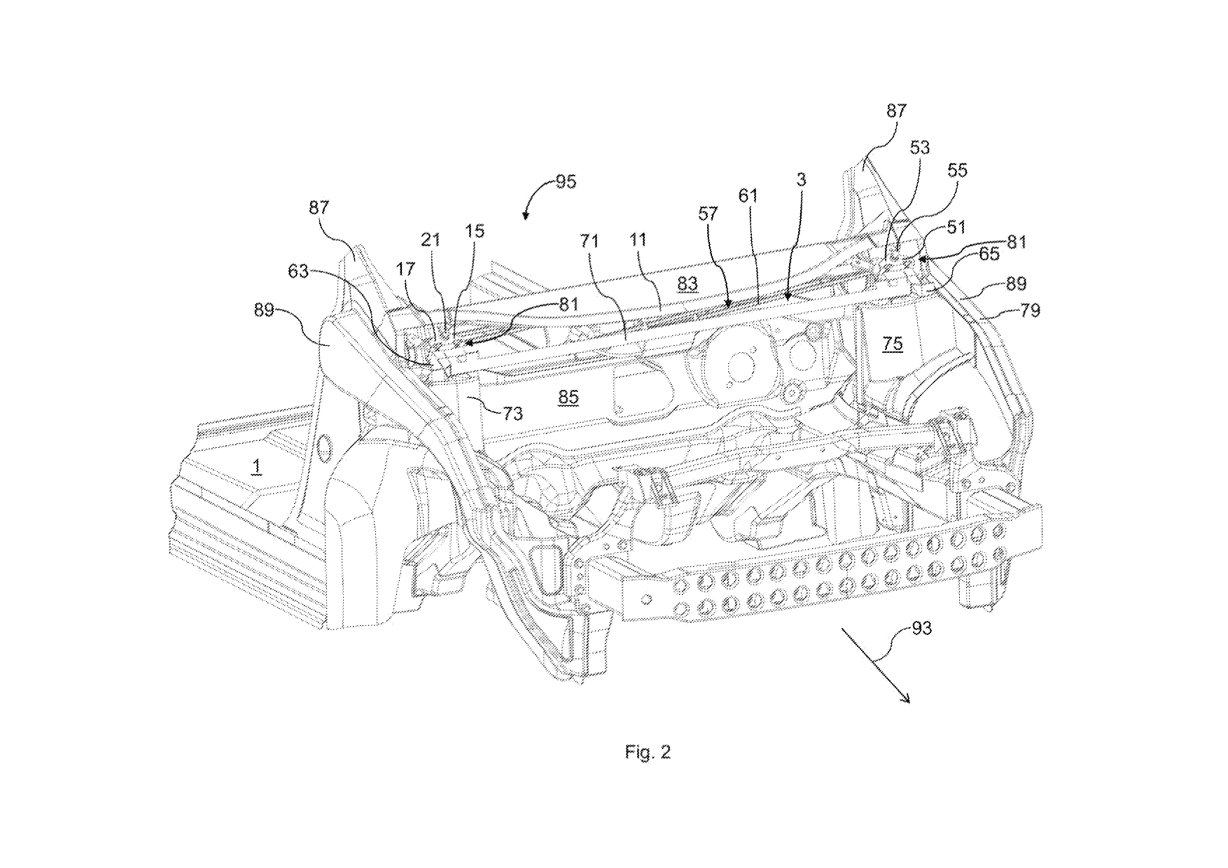

FIG. 2 shows a schematic, inclined view from the top front of a front end 95 of the motor vehicle depicted on FIG. 1. The bumper 9, hood 5 and windshield 7 along with other cover parts are not shown. In evidence is a supporting structure of the front end 95 of a body 79 of the motor vehicle 1. The supporting structure exhibits a pane support 83 for mounting the windshield 7, a bulkhead 85 for delimiting an interior of the motor vehicle 1, two A-columns 87, two wheel suspension struts 89 as well as other supporting parts, such as a lock cross member, a bumper cross member and two longitudinal members.

The windshield wiper device 3 is visible on FIG. 2. The windshield wiper device 3 can be operated in a butterfly operating mode, and to this end exhibits a drive unit 57 with a motor not shown in any greater detail on FIG. 2 and a wiper linkage 61, along with a cross strut 71 for accommodating the drive unit 57. The windshield wiper device 3, in one example, the drive unit 57, is located below the impact region 11.

In addition, the windshield wiper device 3 exhibits a wiper axis 21 as well as another wiper axis 55. Windshield wipers not shown in any greater detail can be powered by the drive unit 57 oppositely to the wiper axes 21, 55, i.e., in the butterfly operating mode. In order to mount the wiper axes 21, 55, the windshield wiper device 3 exhibits a wiper mounting device 17 and another wiper mounting device 53. The latter are used for mounting the wiper axes 21, 55 and fixing them in place on the body 79 of the motor vehicle 1. Each of the wiper mounting devices 17, 53 exhibits an axial body 15 or another axial body 51. The axial bodies 15, 51 are allocated to the body 79 in a mechanically rigid and vibration-decoupled manner by means of a retainer 63 and another retainer 65. The retainers 63 and 65 are here fixed in place on the body 79 via fixing means, in one example, screw connections. The axial bodies 15, 51 are fixed in place on the retainers 63, 65 in a vibration-decoupled manner via rubber bearings. This fixation advantageously also yields a slide bearing, which will be described in greater detail below. The slide bearing can be used to collapse the windshield wiper device 3, meaning that, given an impact with a pedestrian, it can retreat in the direction of impact 13.

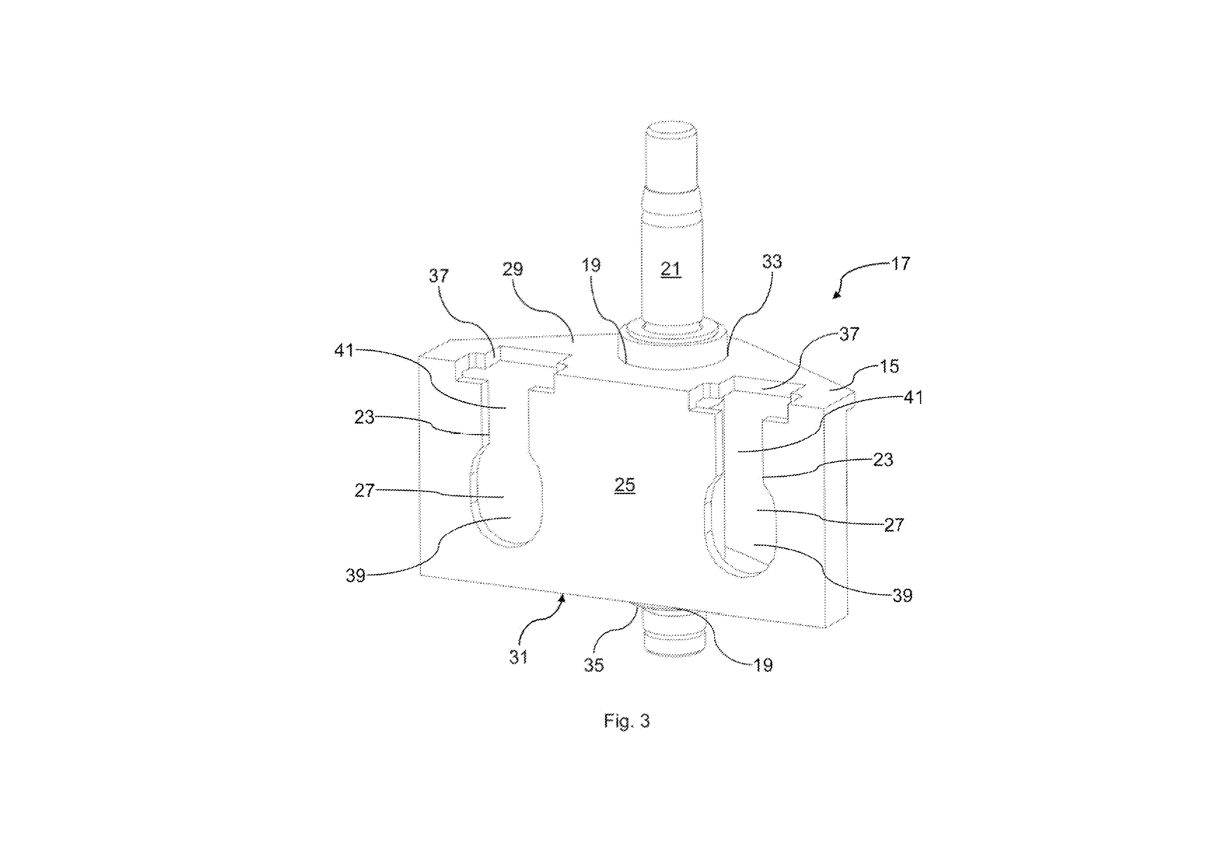

FIG. 3 presents a detailed depiction of the axial body 15 shown on FIG. 2 in an inclined, three-dimensional view from the top rear. The axial body 15 shown on FIG. 3 exhibits a pivot bearing receptacle 19. The pivot bearing receptacle 19 is formed by a bearing bore 33 and another bearing bore 35, wherein the wiper axis 21 is pivoted in the bearing bores 33, 35. The bearing is pivoted by means of two ball bearings, which sit in the bearing bores 33, 35, in one example, are force fit therein.

The bearing bore 33 is introduced into a bearing plate 29 of the axial body 15. The additional bearing bore 35 is introduced into another bearing plate 31 of the axial body 15. The bearing plates 29 and 31 are generally arranged parallel to each other. However, these can in one example, also be situated at a spatial angle relative to each other.

The bearing plates 29 and 31 are each integrally joined as a single piece with a rear wall 25, and situated at an angle to the rear wall, in one example each at an angle of about 90°. The rear wall 25 and the bearing plates 29 and 31 fixed in place thereto as a single piece exhibit a U-shaped cross section. The U-shaped cross section advantageously ensures a high stability. In one example, a reinforcing rib is also arranged between the bearing plates 29 and 31 to the side of the respective rear wall 25, so that the rear wall 25 in conjunction with the reinforcing ribs and bearing plates 29 and 31 yields a denoted half-open box, thereby advantageously further increasing the stability of the axial body 15.

In order to create a slide bearing guide 23, the axial body 15 exhibits at least one oblong recess 27, the present two oblong recesses 27 arranged parallel to each other. The oblong recesses 27 are incorporated into the rear wall 25 of the axial body 15 and, viewed as aligned on FIG. 3, open toward the top, meaning open in a border area between the rear wall 25 and bearing plate 29 toward the outside of the axial body 15. The oblong recess 27 exhibits an expansion 39 next to the additional bearing plate 31. In the following, features of the recesses 27 referred to in the singular along with additional components incorporated therein relate to both, unless expressly stated otherwise.

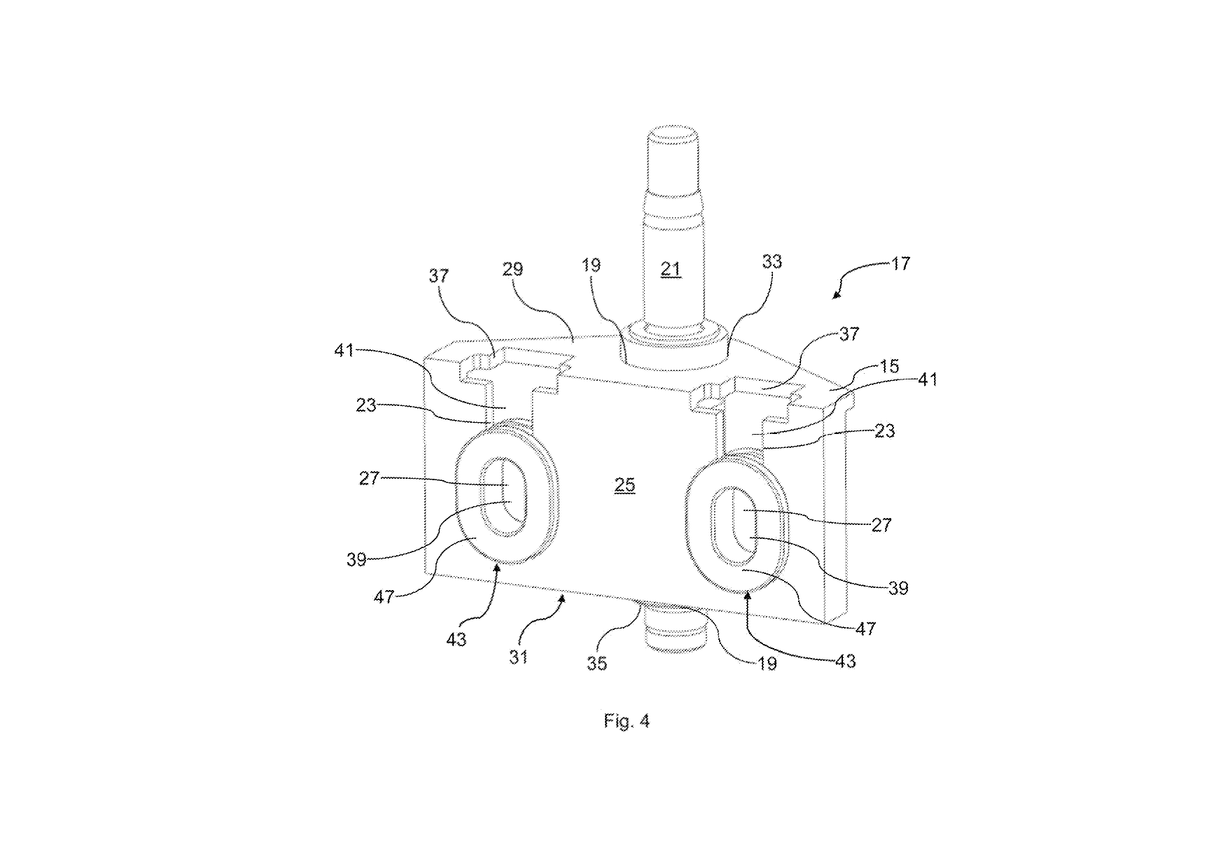

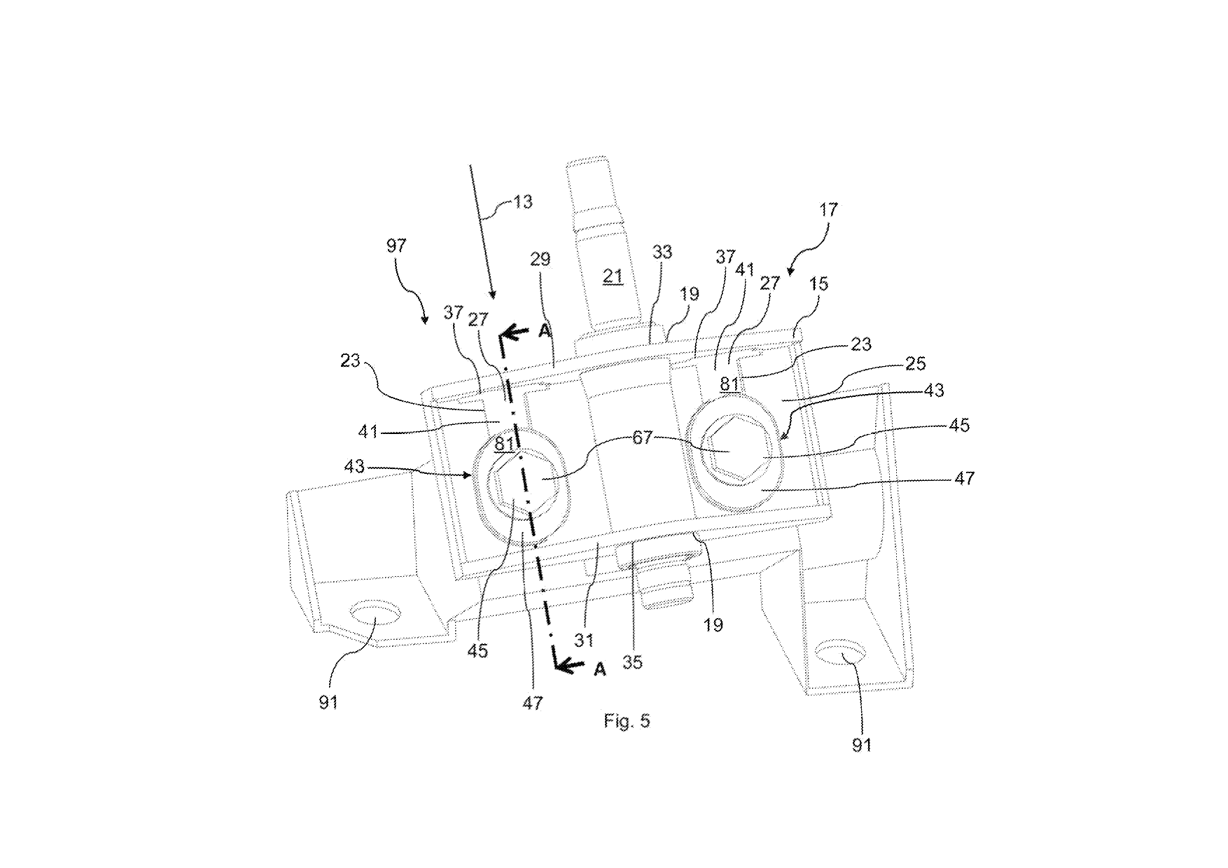

A constriction 41 adjoins the expansion 39 toward the bearing plate 29. The constriction 41 empties into an opening 37 in the bearing plate 29. The opening 37 is graduated in design, so that a screw 67 depicted on FIG. 5 along with a double collar bushing 47 depicted on FIGS. 4 and 5 can glide through the opening 37.

FIG. 4 shows the axial body 15 as depicted on FIG. 3, wherein the double collar bushing 47 is instead positively accommodated in the recess 27. FIG. 5 also shows the axial body 15 in a three-dimensional view, but at an inclination from the top rear, and in an assembled state in conjunction with a retainer 63 for fixation to the body 79.

FIGS. 3-5 will be used below to provide a more detailed description of a slide bearing device 81 comprised of the axial body 15, double collar bushing 47 and screw 67. The slide bearing device 81 allows the axial body 15 to glide along a path of movement prescribed by the constriction 41 toward the impact direction 13 relative to the retainer 63.

In one example, the double collar bushing 47 is given an oval shape to illustrate a compensatory tolerance, i.e., exhibits a centric, elongated hole as well as a peripherally continuous, concentric groove formed by the double collar. The concentric groove is positively accommodated in the expansion 39. The expansion 39 is also oblong or oval in shape, and adjusted to the outer shape of the concentric groove of the double collar bushing 47. As a result, the double collar bushing 47 is advantageously situated positively in the expansion 39 of the oblong recess 27, meaning adjacent to the constriction 41.

When in a state assembled with the retainer 63, the screw 67 penetrates through the elongated hole of the double collar bushing 47, and is screwed to the retainer 63. This advantageously pretensions the double collar bushing 47, i.e., presses it against an interior side and exterior side of the rear wall in an environment of the expansion 39. This additionally yields a non-positive fixation of the double collar bushing 47 to the oblong recess 27.

In addition, the double collar bushing 47 advantageously forms a rubber bearing for decoupling the oscillation of the retainer 63 and axial body 15. Therefore, the axial body 15 and retainer 63 advantageously do not come to directly abut against each other, wherein the double collar bushing 47 is arranged between the latter. In one example, the double collar bushing 47 is rubbery elastic or exhibits rubbery elastic properties. The double collar bushing can advantageously be reversibly elastically deformed.

If the defined force in the impact direction 13 acts on the axial body 15, in one example, on the wiper axis 21 and by way of the latter on the axial body 15, the bearing force generated by the non-positive joining of the double collar bushing 47 with the expansion 39 and positive integration of the double collar bushing 47 is overcome, so that the axial body 15 starts moving toward the impact direction 13 along the slide bearing guide 23. The double collar bushing 47 is elastically deformed in the process, wherein a width of the constriction 41 and the pretension by the screw 67 advantageously prescribe the defined force required to shift the axial body 15. In so doing, it is thus advantageously possible to set the force acting on the wiper axis 21 starting at which the slide bearing device 81 is activated.

To this end, the double collar bushing 47 forms a bearing shoe 43. The bearing shoe 43 is slideably mounted in the oblong recess 27, which exhibits the expansion 39 and constriction 41 adjacent thereto, and forms the slide bearing guide 23.

Any fixing means 45 can be used in place of the screw 67 for joining the axial body 15 with the retainer 63, in one example, a rivet joint and/or a threaded bolt allocated to the retainer 63 in a mechanically fixed manner, and a nut that can be screwed thereupon. In the present case, the retainer 63 exhibits a corresponding thread, into which the screw 67 is screwed.

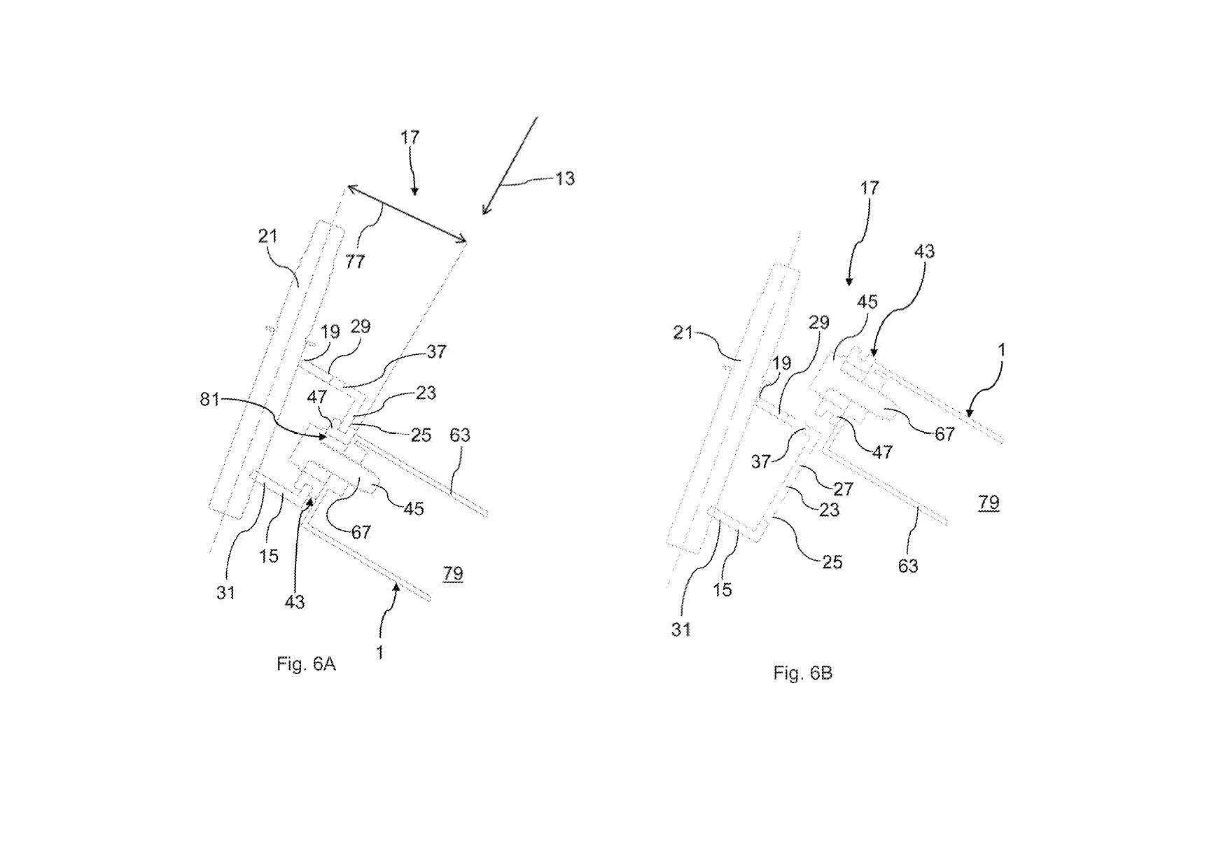

FIGS. 6A and 6B each show a section along the A-A line depicted on FIG. 5. FIG. 6A shows the axial body 15 in the state assembled with the retainer 63, while FIG. 6B shows the axial body 15 in a shifted state, meaning after the defined force has acted toward the impact direction 13, or shifted along the slide bearing guide 23.

As evident from FIGS. 6A and 6B, the wiper axis 21 is situated at an angle 77 to the impact direction 13. The impact direction 13 runs in a plane of a flat expansion of the rear wall 25. Any spatial arrangement of the wiper axis 21 can be advantageously realized in this way, wherein the wiper axis 21 does not depend on the impact direction 13, meaning can advantageously be situated at the angle 77 relative thereto. In order to realize the inclined position of the wiper axis 21, the bearing bores 33 and 35 are incorporated into the bearing plates 29 and 31 in a staggered manner.

As also readily evident from FIGS. 6A and 6B, the oblong recess 27 opens in the direction of the bearing plate 29, wherein the fixing means 45, meaning the screw 67 and the double collar bushing 47 retained by it, which forms the bearing shoe 43, can glide through the opening 37 in the bearing plate 29. FIG. 6B presents a section depicting the corresponding situation in which the axial body 15 is entirely detached from the retainer 63.

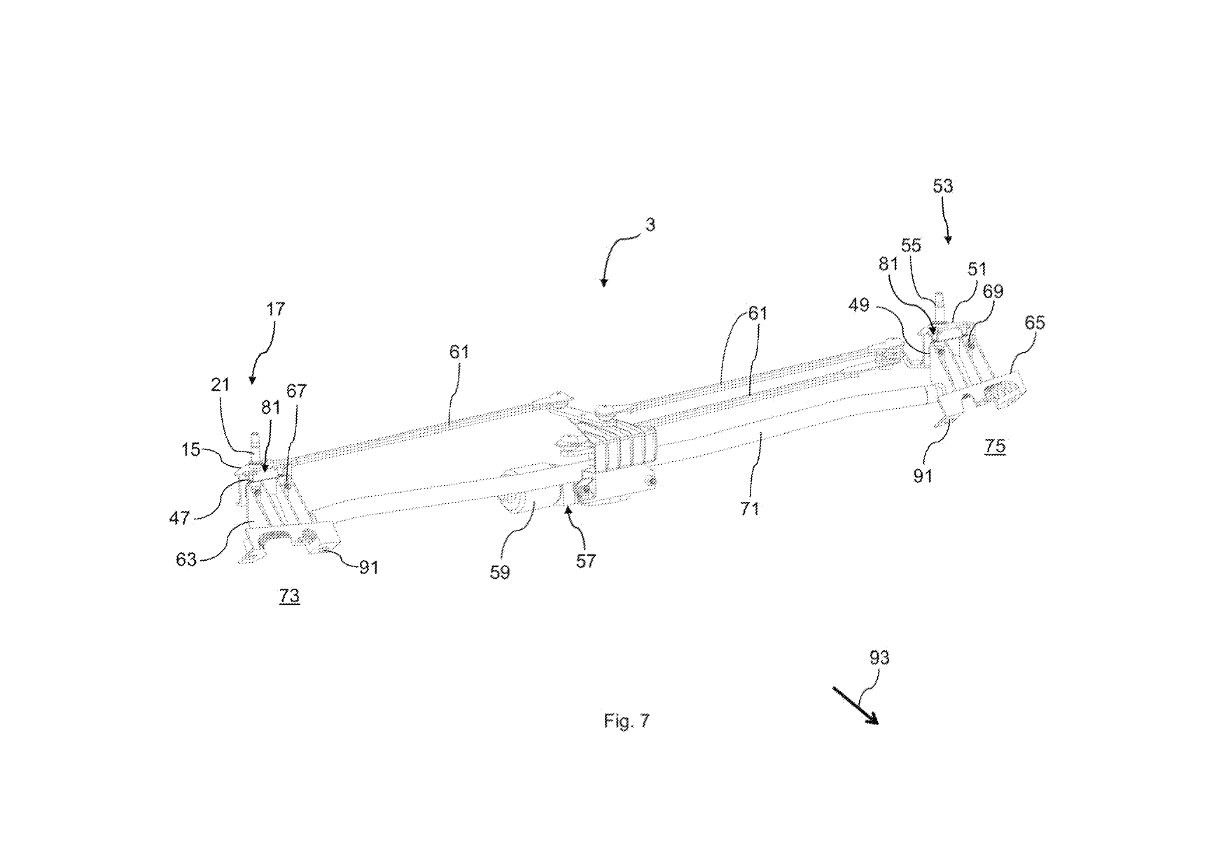

FIG. 7 shows a detailed depiction of a windshield wiper device of the motor vehicle 1 in an inclined, three-dimensional view from the bottom front. A traveling direction 93 is denoted on FIG. 7 by an arrow. As evident, the drive unit 57 of the windshield wiper device 3 can be allocated to the body 79 via the retainer 63 as well as the other retainer 65.

For this purpose, the retainers 63 and 65 each exhibit three through holes 91. The through holes 91 can be used to allocate the retainers 63 and 65 to a spring dome 73 as well as another spring dome 75 of the body 79 of the motor vehicle 1 in a mechanically fixed manner, in one example, screw them to the latter. Alternatively or additionally, any fixing means desired are possible, for example, threaded bolts, rivets, welds and/or the like. Also evident from FIG. 7 is that the cross strut 71 is allocated to the retainers 63 and 65 in a mechanically fixed manner, in one example, connected thereto, for example screwed, welded, riveted and/or hinged. The drive unit 57 is allocated to the body 79 at the cross strut 71 and above the wiper axis 21 and 55 via the axial body 15 and the retainers 63, 65. Another screw 69 is provided to fix the other axial body 51 in place on the other retainer 65.

The drive unit 57 of the windshield wiper device 3 exhibits a motor 59, in one example, an electric motor, and the wiper linkage 61. The wiper linkage 61 comprises a multi-bar linkage for driving the wiper axes 21 and 55 in a butterfly operating mode.

The retainers 63 and 65 can advantageously be allocated to the body 79 in the region of a spring dome 73 and another spring dome 75. These advantageously have a comparatively stiff configuration, so that stabilizing forces can be conveyed between the spring domes 73 and 75 via the cross strut 71. In this way, the cross strut 71 advantageously replaces a lock cross member, and simultaneously assumes the function of a mechanical bearing for the drive unit 57.

In the present example, two double collar bushings 47 or two other double collar bushings 49 as well as two screws 67 and two other screws 69 are provided per axial body 15, 51. The windshield wiper device 3, which comprises a front windshield wiper unit of the motor vehicle 1, is advantageously held on the retainers 63, 65 on the body side, wherein the latter collapse during an impact with a pedestrian, and hence when the defined force is applied toward the impact direction 13, and advantageously permit the wiper axis 21, 55 to shift toward the impact, i.e., the impact direction 13. This advantageously diminishes the risk of injury to the pedestrian, since this collapsible system reduces arising deceleration values. The wiper axes 21, 55 are each attached to the corresponding axial body 15. The axial bodies 15, 51 are generally fabricated in a casting process, in one example, via plastic injection molding or light metal die casting, and have one or two brackets in the form of the oblong recesses 27 for attachment to the body-side retainers 63, 65. Incorporated into the brackets or oblong recesses 27 are holes or the expansions 39, which are open in the direction of an attachment of wiper arms. Elastic bearing elements, the double collar bushings 47, are mounted in the constrictions 41 to prevent vibrations from being transferred to the body 79 in the region of the windshield wiper device 3. The oblong recesses 27 exhibit the constriction 41 above the double collar bushings 47.

A spatial arrangement or alignment of the oblong recesses 27 or their longitudinal direction for attachment to the body-side retainers 63 and 65 is generally selected in accordance with the theoretical impact direction 13 of the pedestrian on the hood 5 or windshield wiper device 3, and can deviate in terms of the form of the angle 77 from the direction of the wiper axes 21, 55. When a pedestrian impacts the windshield wiper device 3, a force acts along the mounting surface of the rear wall 25 between the axial body 15 and a corresponding abutment surface of the body-side retainer 63. An improved pedestrian protection and reduced risk of injury are advantageously achieved. This advantageously makes repairs simple and cost-effective, and yields a robust system with respect to angular deviations. For repair purposes, the axial body 15 can easily be returned to its original position again, wherein the bearing shoe 43 formed by the double collar bushing 47 is to this end mounted in the expansion 39 once more.

In one example, the cross strut 71 of the windshield wiper device 3 that can operate in the butterfly operating mode, i.e., oppositely, is simultaneously designed as a strut brace to provide reinforcement between the spring domes 73 and 75. The cross strut 71, which is designed like a reinforcing pipe for accommodating wiper components, in one example, the drive unit 57, is fixed in place by the retainers 63 and 65, and thus allocated to the body 79 in a mechanically rigid manner.

Advantageously provided at the two ends of the cross strut 71 are retainers 63 and 65, which are used on the one hand for attaching the wiper axes 21 and 55 via the axial bodies 15 and 51, and on the other for attaching the assembled windshield wiper device to the body 79. In one example, the cross strut 71 is welded to the retainers 63, 65. Provided in a central region of the cross strut 71 is another retainer for attaching the motor 59, in one example, via welding, screwing and/or the like. Any welded joints that may be present are designed in such a way that forces introduced into a body structure of the body 79 via spring struts of the motor vehicle while driving do not allow any relative movements between the cross strut 71 designed as a reinforcing pipe and the retainers 63, 65. The components of the windshield wiper device, in one example, the drive unit 57, motor 59, wiper linkage 61, wiper axes 21, 55, drive and reverse linkages, reverse cranks and others, are completely assembled into a modular unit on the reinforcing pipe or cross strut 71 with the attached, in one example, welded retainers 63, 65. The entire modular unit is advantageously mounted to the body 79 in a final assembly step, wherein centering means on the body 79 simplify positioning and can minimize installation tolerances, wherein attachment takes place by means of fastening screws. The reduction of individual parts and curtailment of assembly operations advantageously yields a cost decrease. In one example, a reduction in weight is achieved by consolidating components, for example, in the form of the advantageous cross strut 71. In addition, no attachments to the vehicle bulkhead 85 are required, wherein noise transmissions can be minimized. Tolerance improvements also arise, especially if the axial bodies 15, 51 are designed as cast parts. A packaging situation in the region of the windshield wiper device is improved as well, since the reinforcing cross strut eliminates the need for otherwise required reinforcements in the region of the front end of the motor vehicle 1.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. An axial body for a wiper pivot device of a motor vehicle, comprising:
a pivot bearing receptacle, in which a wiper axis is pivoted; and
a slide bearing guide, along which the axial body as a whole is shiftable when the axial body is exposed to a defined force.

2. The axial body according to claim 1, wherein the axial body exhibits a rear wall with at least one oblong recess, which comprises the slide bearing guide.

3. The axial body according to claim 1, wherein the axial body exhibits a bearing plate with a bearing bore, which comprises the pivot bearing receptacle.

4. The axial body according to claim 1, wherein the wiper axis is situated at an angle to the rear wall.

5. The axial body according to claim 4, wherein the bearing plate exhibits an opening, which adjoins the oblong recess.

6. The axial body according to claim 5, wherein the oblong recess exhibits an expansion and a constriction that adjoins the expansion, wherein the expansion incorporates a bearing shoe.

7. The axial body according to claim 6, wherein the constriction empties in the opening of the bearing plate.

8. The axial body according to claim 7, wherein the axial body exhibits a second bearing plate with a second bearing bore spaced apart from the bearing plate, which in conjunction with the bearing bore and bearing plate forms the pivot bearing receptacle.

9. A windshield wiper device of a motor vehicle, comprising:
an axial body including a pivot bearing receptacle, in which a wiper axis is pivoted; and
a slide bearing guide, along which the axial body as a whole is shiftable when the axial body is exposed to a defined force,
wherein the axial body exhibits a bearing plate with a bearing bore, which comprises the pivot bearing receptacle.

10. The windshield wiper device according to claim 9, further comprising a wiper pivot device, which exhibits the axial body, a bearing shoe positively mounted in the slide bearing guide so that it glides, and a fixing means with which the bearing shoe is mechanically fixed in place on the motor vehicle.

11. The windshield wiper device according to claim 10, wherein the bearing shoe is designed as a rubbery elastic double collar bushing.

12. The windshield wiper device according to claim 11, wherein the fixing means exhibits a screw that penetrates through the double collar bushing.

13. The windshield wiper device according to claim 12, further comprising a second axial body of a second wiper pivot device for pivoting the wiper axis and a second wiper axis, a drive unit with which the wiper axis and second wiper axis are oppositely driven in a butterfly operating mode, a retainer that is fixedly coupled to a body of the motor vehicle and has screwed to it the axial body via the screw penetrating through the double collar bushing, a second retainer that is fixedly coupled to the body of the motor vehicle and has screwed to it the second axial body via a second screw penetrating through a second double collar bushing.

14. The windshield wiper device according to claim 13, further comprising a cross strut that is arranged between the retainer and second retainer, that is mechanically rigidly allocated to the retainer and second retainer, and has fixed in placed on it the drive unit.

15. A motor vehicle, comprising:
a windshield wiper device of a motor vehicle including an axial body having a pivot bearing receptacle, in which a wiper axis is pivoted and a slide bearing guide, along which the axial body as a whole is shiftable when the axial body is exposed to a defined force,
wherein the axial body exhibits a rear wall with at least one oblong recess, which comprises the slide bearing guide.

16. The motor vehicle according to claim 15, further comprising a wiper pivot device, which exhibits the axial body, a bearing shoe positively mounted in the slide bearing guide so that it glides, and a fixing means with which the bearing shoe is mechanically fixed in place on the motor vehicle.

17. The motor vehicle according to claim 16, wherein the bearing shoe is designed as a rubbery elastic double collar bushing.

18. The motor vehicle according to claim 17, wherein the fixing means exhibits a screw that penetrates through the double collar bushing.

19. The motor vehicle according to claim 18, further comprising a second axial body of a second wiper pivot device for pivoting the wiper axis and a second wiper axis, a drive unit with which the wiper axis and second wiper axis are oppositely driven in a butterfly operating mode, a retainer that is fixedly coupled to a body of the motor vehicle and has screwed to it the axial body via the screw penetrating through the double collar bushing, a second retainer that is fixedly coupled to the body of the motor vehicle and has screwed to it the second axial body via a second screw penetrating through a second double collar bushing.

20. The motor vehicle according to claim 19, further comprising a cross strut that is arranged between the retainer and second retainer, that is mechanically rigidly allocated to the retainer and second retainer, and has fixed in placed on it the drive unit.
